(19) United States
(12) Patent Application Publication
(10) Pub. No.: US 2009/0060105 A1
(43) Pub. Date: Mar. 5, 2009

(54) INTERFERENCE LEVEL ESTIMATION OF PATH MONITORING IN W-CDMA USING THE ORDER STATISTICS OF BEAULIEU SERIES

(76) Inventors: Oguz Tanrikulu, New York, NY (US); Frank C. Livingston, Richardson, TX (US); Tarik Muharemovic, Dallas, TX (US)

Correspondence Address: TEXAS INSTRUMENTS INCORPORATED, P O BOX 655474, M/S 3999, DALLAS, TX, 75265, US

(21) Appl. No.: 11/848,558

(22) Filed: Aug. 31, 2007

(51) Int. Cl. H04B 1/10; H04J 11/00

(52) U.S. Cl. 375/346; 370/206

(57) ABSTRACT

A technique for interference level estimation for a WCDMA system based on the low order statistics of Beaulieu Series is provided. Correlation of a locally generated copy of a dedicated physical control channel (DPCCH) with the input samples of the radio frequency message is performed using low order statistics of a Beaulieu Series to estimate an interference level and thereby implicitly separate a set of multipath components from a noise floor.

### FIELD OF THE INVENTION

This invention generally relates to cellular telephone transmission, and in particular to W-CDMA systems.

### BACKGROUND OF THE INVENTION

The Global System for Mobile Communications (GSM: originally from Groupe Spécial Mobile) is currently the most popular standard for mobile phones in the world and is referred to as a 2G (second generation) system. W-CDMA (Wideband Code Division Multiple Access) is a type of 3G (third generation) cellular network. W-CDMA is the higher speed transmission protocol designed as a replacement for the aging 2G GSM networks deployed worldwide. More technically, W-CDMA is a wideband spread-spectrum mobile air interface that utilizes the direct sequence Code Division Multiple Access signaling method (or CDMA) to achieve higher speeds and support more users compared to the older TDMA (Time Division Multiple Access) signaling method of GSM networks.

In a CDMA system, channels are broadcast on the same frequency using orthogonal spreading codes or patterns. The orthogonal nature of these patterns means that when a reference pattern is correlated with a received pattern, the result is 0 for all other signals that are not required. For the desired signal, the result is non-zero, with the sign ultimately giving the value of the transmitted bit, that is 0 or 1. Table 1 shows the results of multiplying each of the orthogonal vectors with each of the reference vectors for a spreading factor of 4. A spreading factor of 4 means that each bit that is sent and received is represented by 4 chips.

TABLE 1
CDMA Orthogonal Codes

| | (1, 1, | | | |
|---|---|---|---|---|
| | 1, 1) | (1, 1, −1, −1) | (1, −1, 1, −1) | (1, −1, −1, 1) |
| (1, 1, 1, 1) | 4 | 0 | 0 | 0 |
| (1, 1, −1, −1) | 0 | 4 | 0 | 0 |
| (1, −1, 1, −1) | 0 | 0 | 4 | 0 |
| (1, −1, −1, 1) | 0 | 0 | 0 | 4 |

To obtain a unity gain system, the result is divided by the spreading factor, which is 4 in this example, as shown in Table 1. In various embodiments, spreading factors as large as 256 may be deployed. Implementing only the spreading codes however is not enough. Long runs of 1s or (−1s) can be produced and this affects both clock recovery and transmitted power levels. Also, if an adjoining cell uses the same spreading pattern, there could be a conflict. To avoid both these problems, the data values are scrambled with a known pseudo-random scrambling code that both separates adjoining cells and removes the long runs. This scrambling code is always different between adjoining cells. Also, if the maximum delay path (delay spread) is greater then a bit period, the receiver has a better chance of determining bit synchronization by using the spreading and scrambling codes together.

Mobile radio environments require that both the mobile station transceiver (MT) and base station transceiver (BTS) maintain a high-quality link, regardless of the position of the MT within the cell. It cannot be assumed that the aerials for both the MT and the BTS are positioned correctly to eliminate multipath signals. Therefore, for narrow-band systems, where there are a small number of strong multipath signals at the receiver falling within a symbol period, software-based channel equalization has been used to correct inter-symbol interference (ISI). Due to the wideband nature of CDMA systems (that is, high chip rates), these paths can be more than one CDMA bit (chip) wide and as such, traditional equalization is no longer an option. Instead, a technique is needed that receives all the paths and then combines them. A rake receiver is a class of receiver that receives signals on as many multi-paths as possible. The rake receiver combines the signals from all of these paths to produce one clear signal that is stronger than the individual components. Individual paths are found (synchronized to) by cross-correlating a reference pattern with the received signal.

The data and control channels are transmitted on the in-phase (I) and quadrature (Q) components of the radio system respectively (D_{I}+jD_{Q}).). These signals are scrambled by a complex scrambling code C_{I}+jC_{Q}, by mixing, producing C_{I}D_{I}+jC_{Q}D_{Q}. All other components are zero because there is no Q component in an I signal, nor is there an I component in a Q signal. In this standard, a known data pattern is transmitted on the first 6 bits of the control channel. By mixing the reference signal, scrambling code, and the known data pattern, a much longer reference correlation model can be obtained. This pattern is then used to search for a particular channel. This known data pattern, or pilot, is used in the search correlations to increase the length and accuracy of the search. Because this reference pattern is the same for all radio paths between the mobile and the base station, it should be calculated only once before it is used to correlate.

Only the pilot bits of the control channel are known. These are transmitted on the Q channel, but the received signal (RX) is of unknown phase relative to the transmitted signal (TX); therefore, cross-correlation must be performed on both the I and Q channel (see prior art FIG. 1 and equations (a) and (b)).

I_{RX}=I_{TX}×r cos θ−Q_{TXx}r sin θ (a)

Q_{RX}=Q_{TXx}r cos θ+I_{TXx}r sin θ (b)

Because the transmitted I channel I_{TX} is known to be orthogonal to the transmitted Q channel Q_{TX} and correlation is performed on the Q channel reference, the Q channel correlates to □1 and the I channel correlates to 0. Therefore, the previous equation becomes:

I_{RX}=r sin θ (c)

Q_{RX}=r cos θ (d)

For any θ, cos²θ+sin²θ=1; therefore, by squaring and adding cos and sin, r² can be obtained. Because the purpose of all these correlations is to find the maximum paths, there is no need to compute the square root to obtain the real r since squares are also real values that can be compared.

If the path is valid, the values in I_{RX} and Q_{RX} can be used to calculate weights for the I and Q channels when they are combined for data extraction later. Because the individual channels are weighted according to their importance, only a crude normalization is done initially. Small errors are corrected by the convergence of the weighting factors. As discussed in more detail in “Implementation of a WCDMA rake Receiver on a TMS320C62x™ DSP Device,” (SPRA680, July 2000, Texas Instruments), incorporated herein by reference, a rake receiver can be implemented using a digital signal processor (DSP).

### BRIEF DESCRIPTION OF THE DRAWINGS

Particular embodiments in accordance with the invention will now be described, by way of example only, and with reference to the accompanying drawings:

FIG. 1 is a plot illustrating phase rotation of a received signal relative to a transmitted signal in W-CDMA transmission;

FIG. 2 is a flow diagram illustrating the basic operation of a WDCMA receiver using an embodiment of the present invention;

FIG. 3 is a plot of probability density function for a sum of L i.i.d. Rayleigh random variables of a set of results for σi=1.0, on fZ_{L} (z) for various values of L using the same set of parameters in the Beaulieu series;

FIG. 4 a plot of Order Statistics of Beaulieu Series for the lowest 8 observations in a PM search window of 256 half-chips with L=4;

FIG. 5, which is a plot of PM correlator output for 12.2 kbps W-CDMA channel at E_{c}/Nₒ=−10 dB, L=6, and W=256; and

FIG. 6 is a block diagram of a representative cell phone that includes an embodiment of the present invention.

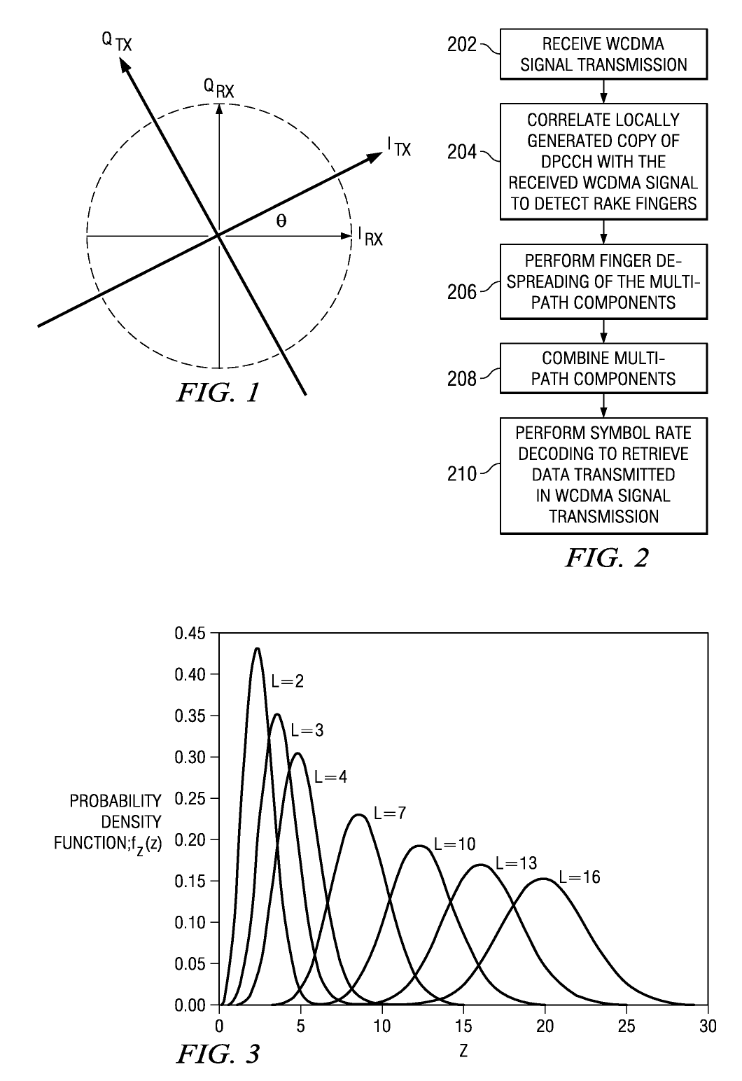

### DETAILED DESCRIPTION OF EMBODIMENTS OF THE INVENTION

It has now been discovered that Beaulieu Series are useful for estimating interference levels for path monitoring in W-CDMA uplink and downlink where the series is expressed in terms of lower incomplete gamma functions in order to simplify its numerical computation. A new technique for interference level estimation for a WCDMA system based on the low order statistics of Beaulieu Series is described herein. Through this technique, the multi-path components and the noise floor are implicitly separated by using the observations on the lower-end of the tail of Beaulieu Series. Simulations results are presented that show the accuracy of the interference level estimate.

FIG. 2 is a flow diagram illustrating the basic operation of a WDCMA receiver using an embodiment of the present invention. A WCDMA signal transmission is received 202 and provided to a Rake receiver. The WCDMA signal includes in-phase and quadrature input samples of data being transmitted. The samples in this embodiment are converted by an input modem to 8-bit I/Q samples that are stored in a buffer as they are received. The Rake receiver performance in a W-CDMA system is closely related to the estimation of various quantities such as the interference level estimate used for Path Monitoring (PM). In PM, a locally generated copy of the Dedicated Physical Control Channel (DPCCH), which carries the spread pilot symbols are correlated 204 with the incoming W-CDMA signal samples provided by the input buffer. Correlations between the incoming WCDMA signal and a locally generated reference are computed over a search window for a number of ‘coherent’ accumulations which are Rayleigh distributed. As this operation is performed over the search window, fingers (i.e. multi-path components) are detected from the resulting PM search profile. Finger de-spreading operations 206 are initiated around the detected multi-path components that are subsequently combined 208. Finally, the symbol-rate decoding 210 is performed to retrieve the data transmitted by the transmitting device. This process is performed at a base station to receive WCDMA signals transmitted by mobile cellular phones, and is also performed by mobile cellular phones to receive WCDMA signals transmitted by base stations.

Those skilled in the art will understand how the receive process 202, finger dispreading process 206, multipath combination 208 and symbol rate decoding process 210 are performed and they will therefore not be described in more detail herein. A general description is provided in US 20050254604, Samuel J. MacMullan, et al, filed Apr. 18, 2005, which is incorporated herein by reference. In this disclosure, the estimation of the interference level used during correlation process 204 is addressed. While it is possible to simply average out the PM search profile results to get an estimate, the result would be skewed since the finger information and the interference level information are mixed together in a given PM search profile. In other schemes such as discussed in “Path Search Performance and Its Parameter Optimization of Pilot Symbol-Assisted Coherent Rake Receiver for W-CDMA Mobile Radio,” S. Fukumoto, K. Okawa, K. Higuchi, M. Sawahashi and F. Adachi, (IEICE Trans. Fundamentals, vol. E83-A, no. 11, pp. 2110-2119, November 2000), referred to later as “Fukumoto”, it is assumed that there is an upper bound on the number of fingers. In this scheme the PM search results are sorted and the lower values are averaged to estimate the interference level. The accuracy of this estimate can be poor if the maximum number of fingers assumed is exceeded.

The PM search profile described in this disclosure is constructed as the sum of a number of Rayleigh distributed random variables. Therefore, the interference level estimation is closely tied with the Beaulieu Series. This is a representation of the distribution of the sum of independent, identically distributed (i.i.d) Rayleigh random variables that is not easy to work with. The general nature of Beaulieu Series is described in more detail in “An Infinite Series for the Computation of the Complementary Probability Distribution Function of a Sum of Independent Random Variables and Its application to the Sum of Rayleigh Random Variables”, N. C. Beaulieu, (IEEE Trans. Comm., vol. 38, no. 9, pp. 1463-1474, September 1990), referred to later as Beaulieu-1. A simpler form is described in “Accurate Simple Closed-Form Approximations to Rayleigh Sum Distributions and Densities”, J. Hu, N. C. Beaulieu, (IEEE Comm. Letters, 2004), referred to latter as Beaulieu-2. Further improvements to the Beaulieu Series will be described below. A method for estimating the interference level using the order statistics of the Beaulieu Series is then described. Simulation results are presented to illustrate one embodiment of the series; other coefficients may be used to produce varying results.

### Beaulieu Series

In Beaulieu-1, the complementary distribution function, G_{ZL} (•), of a sum of i.i.d Rayleigh random variables

$${Z}_{L} = {\sum }_{i = 1}^{L} {Z}_{i} \qquad ( 1 )$$

is derived in series form as

$$\begin{matrix} {G}_{{Z}_{L}} ( ε L ) = \frac{1}{2} + \frac{2}{π} {\sum }_{\begin{matrix}n = 1 \\ n : odd\end{matrix}}^{∞} \frac{{A}_{i , n}^{L}}{n} sin ( L {θ}_{i , n} ) \\ where & ( 2 ) \\ {A}_{i , n} = \sqrt{{}_{1}^{}{F}{}_{1}^{2} ( 1 , \frac{1}{2} , \frac{- {n}^{2} {ω}^{2} {σ}_{i}^{2}}{2} ) + \frac{π}{2} {n}^{2} {ω}^{2} {σ}_{i}^{2} {e}^{- {n}^{2} {ω}^{2} {σ}_{i}^{2}}} & ( 3 ) \\ tan ( {θ}_{i , n} ) = \frac{\sqrt{\frac{π}{2}} n ω {σ}_{i} {e}^{\frac{- {n}^{2} {ω}^{2} {σ}_{i}^{2}}{2}} - {}_{1}^{}{F}{}_{1}^{} ( 1 , \frac{1}{2} , \frac{- {n}^{2} {ω}^{2} {σ}_{i}^{2}}{2} ) tan ( n ω ε )}{{}_{1}^{}{F}{}_{1}^{} ( 1 , \frac{1}{2} , \frac{- {n}^{2} {ω}^{2} {σ}_{i}^{2}}{2} ) + \sqrt{\frac{π}{2}} n ω {σ}_{i} {e}^{\frac{- {n}^{2} {ω}^{2} {σ}_{i}^{2}}{2}} tan ( n ω ε )} & ( 4 )\end{matrix}$$

where ω=2π/T and T defines a real, positive interval. ₁F₁(•, •, •) in (3), (4) is the confluent hypergeometric function of the first kind. In Beaulieu-1, approximations are presented for the evaluation of ₁F₁(•, •, •). A Small Argument Approximation (SAA) of the series was first presented in Beaulieu-1. This approximation is not accurate for the high-end tail of the distribution. Therefore, a least-squares technique is used in Beaulieu-2 where the error term in the SAA is characterized by a functional form, whose parameters are determined to minimize the difference between the original series and the SAA as modified by the error term.

It has now been discovered that the original series in (2-4) can be rewritten in terms of other special functions which makes it easier to evaluate the Beaulieu Series. The lower incomplete gamma function is defined as

$$γ ( a , x ) = {\int }_{0}^{x} {t}^{a - 1} {e}^{- t} d t \qquad ( 5 )$$

Also note that the following identities exist as defined by “Table of Integrals, Series, and Products”, M. Ryzhik, I. S. Gradshteyn, (Alan Jeffrey (Editor), Academic Press Inc., London, 1994):

$$\begin{matrix}γ ( a , x ) = \frac{{x}^{a}}{{a}_{1}} {F}_{1} ( a , a + 1 , - x ) & ( 6 ) \\ {}_{1}^{ }{F}{}_{1}^{ } ( 1 , \frac{1}{2} , - x ) = {e}_{1}^{- x} {F}_{1} ( - \frac{1}{2} , \frac{1}{2} , x ) & ( 7 ) \\ Γ ( a - 1 , x ) = \frac{1}{a - 1} ( Γ ( a , x ) - {e}^{- x} {x}^{a - 1} ) & ( 8 ) \\ Γ ( a , x ) + γ ( a , x ) = Γ ( a ) & ( 9 )\end{matrix}$$

Using (6) and (7) we can write

$${}_{1}^{ }{F}{}_{1}^{ } ( 1 , \frac{1}{2} , x ) = - \frac{1}{2} \sqrt{x} {e}^{x} γ ( - \frac{1}{2} , x ) \qquad ( 10 )$$

Furthermore, by using (8) and (9) in (10), we get

$$γ ( - \frac{1}{2} , - x ) = Γ ( - \frac{1}{2} ) - 2 Γ ( \frac{1}{2} ) + 2 γ ( \frac{1}{2} , - x ) - 2 j {e}^{x} {x}^{- 1 / 2} \qquad ( 11 )$$

where j=\sqrt{−1}. Note that the first argument of γ(•, •) on the right-hand side of (11) is positive and therefore (11) can be computed using standard numerical analysis techniques. Using (11) and (10) in (3) and (4), the Beaulieu Series can be rewritten as

$$\begin{matrix}{A}_{i , n} = \frac{n ω {σ}_{i}}{2 \sqrt{2}} {e}^{\frac{- {n}^{2} {ω}^{2} {σ}_{i}^{2}}{2}} \sqrt{4 π - {γ}^{2} ( - \frac{1}{2} , \frac{- {n}^{2} {ω}^{2} {σ}_{i}^{2}}{2} )} & ( 12 ) \\ {θ}_{i , n} = arctan ( \frac{2 \sqrt{π} + j γ ( - \frac{1}{2} , \frac{- {n}^{2} {ω}^{2} {σ}_{i}^{2}}{2} ) tan ( n ω ε )}{2 \sqrt{π} tan ( n ω ε ) - jγ ( - \frac{1}{2} , \frac{- {n}^{2} {ω}^{2} {σ}_{i}^{2}}{2} )} ) & ( 13 )\end{matrix}$$

Note that jγ(−½, −x) is real and therefore the terms in (12) and (13) are real. The other functions of interest are the cumulative distribution function of Z_{L} defined as F_{Z}_{_{L}} (z)=1−G_{Z}_{_{L}} (z), and the probability density function defined as f_{Z}_{_{L}} (z)=dF_{Z}_{_{L}} (z)/dz. During the numerical evaluation of the Beaulieu Series from (2), (12), and (13), it is observed that convergence is much more rapid when L is even than when it is odd. To remedy this situation, since Zᵢ are i.i.d, we use fZ₂ₖ=fZ₂ₖ₋₁*fZ₁, where * is linear convolution and Z₁ is Rayleigh distributed according to

$${f}_{{Z}_{i}} ( z ) = \{ \begin{matrix}\frac{z}{{σ}_{i}^{2}} {e}^{- \frac{{z}^{2}}{2 {σ}_{i}^{2}}} & z \geq 0 \\ 0 & z < 0\end{matrix} \qquad ( 14 )$$

FIG. 3 is a plot of probability density function (pdf) for a sum of L i.i.d. Rayleigh random variables of a set of results for σi=1.0, on fZ_{L} (z) for various values of L using the same set of parameters in the Beaulieu series according to equations (2), (12) and (13). Note that 1000 terms are used in the truncated series and T=1000.

For reasons that will be become clear in the next sections, we are interested in the distribution of a specific outcome in terms of its order when a number of independent Beaulieu observations are made. Let us assume that

Z_{L,[W ]}={Z_{1,L,W},Z_{2,L,W}. . . , Z_{p,L,W}, . . . , Z_{W,L,W}} (15)

be W independent observations of a Beaulieu Series of sum of L i.i.d Rayleigh random variables sorted from largest to smallest. The probability density function of ZL,p is given according to the following order statistic relationship, as defined in “Order Statistics”, H. A. David, H. N. Nagaraja, (3-rd Edition, John Wiley & Sons Inc., New Jersey, 2003):

$${f}_{{Z}_{L , p}} ( z ) = \frac{W !}{( p - 1 ) ! ( W - p ) !} {F}_{{Z}_{L}}^{W - p} ( z ) {G}_{{Z}_{L}}^{p - 1} ( z ) {f}_{{Z}_{L}} ( z ) \qquad ( 16 )$$

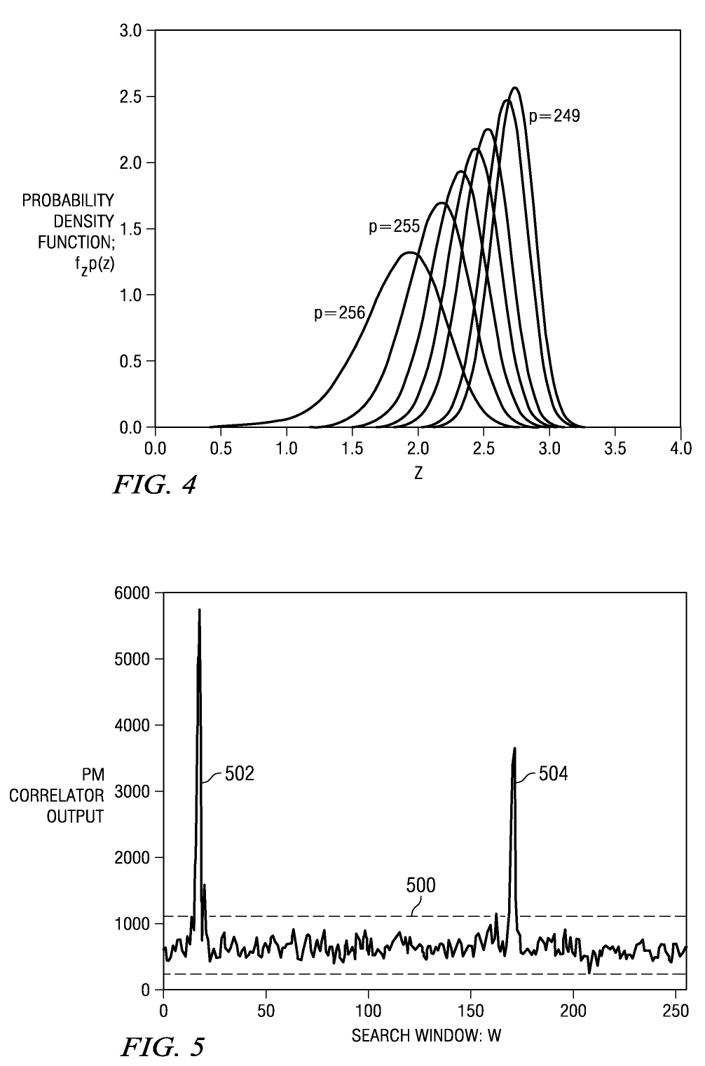

Examples of such densities are shown in FIG. 4 which is a plot of Order Statistics of Beaulieu Series for the lowest 8 observations in a PM search window of 256 half-chips with L=4. The vertical axis represents probability density function f_{z}p(z) for p-th highest observation for W=256, L=4.

### Path Monitoring

Path Monitoring (PM) is an important element of a Rake receiver where the correlations between the incoming WCDMA signal and a locally generated reference are computed over a search window for a number of ‘coherent’ accumulations which are Rayleigh distributed. Note that we assume that the interference due to channel noise and other users is Gaussian distributed. The coherent accumulations are then accumulated further as in (1). Therefore, the noise floor in a resulting PM search profile is distributed according to the Beaulieu Series. Such a PM search profile is shown in FIG. 5, which is a plot of PM correlator output for 12.2 kbps W-CDMA channel at E_{c}/Nₒ=−10 dB, L=6, and W=256. Noise floor 500 is distributed according to the Beaulieu Series. Multipath fingers 502 and 504 are implicitly separated from the noise floor.

The core objective of PM is to decide on whether or not multi-path fingers exist in a given PM search profile such as in FIG. 5. This requires the characterization of the underlying Beaulieu Series. However, since the finger information and the interference are mixed, there is no straightforward way of estimating σi. Note that we assume σi=σ. One way of estimating σ is to use the order statistics of the Beaulieu series. Given a PM search profile, the samples are sorted from largest to the smallest. The smallest few observations are then attributed due to noise. Given that fact the distribution of these order statistics are known, σ can be estimated.

Let us define the normalized random variable

$${\tilde{Z}}_{L} = {Z}_{L} / σ \\ From ( 14 ) , we have \\ E \{ {\tilde{Z}}_{L} \} = \sqrt{\frac{π}{2}} L , Var \{ {\tilde{Z}}_{L} \} = ( 2 - \frac{π}{2} ) L \qquad ( 17 )$$

Hence, \tilde{Z}L has a distribution where σ=1. Let the sorted set of W observations of \tilde{Z}L be defined as

\tilde{Z}_{L,[W]}={\tilde{Z}_{1,L,W}, \tilde{Z}_{2,L,W}, . . . , \tilde{Z}_{p,L,W}, . . . , \tilde{Z}_{W,L,W}} (18)

By using (17) in (18), we have

$${\tilde{Z}}_{L , [ W ]} = \{ \frac{{Z}_{1 , L , W}}{σ} , \frac{{Z}_{2 , L , W}}{σ} , … , \frac{{Z}_{p , L , W}}{σ} , … , \frac{{Z}_{W , L , W}}{σ} \} \qquad ( 19 )$$

Note in order to estimate σ the mean of the order statistics for \tilde{Z}p,L,W is computed from (16) through numerical computation of the integral

$${ξ}_{p , L , W} = E \{ {\tilde{Z}}_{p , L , W} \} = {\int }_{- ∞}^{∞} {zf}_{{\tilde{Z}}_{p , L , W}} ( z ) d z \qquad ( 20 )$$

where σ=1 in the underlying distributions in (16). Various values of ξp,L,W are be tabulated in Table 2. If the number of lowest observations used for the estimation of σ is denoted by M, then the estimate for σ can be computed as

$${σ}_{est} = \frac{1}{M} {\sum }_{i = W - M + 1}^{W} \frac{{Z}_{i , L , W}}{{ξ}_{i , L , W}} \qquad ( 21 )$$

Then, the estimate of the average interference level is simply given by

$$E {\{ {Z}_{L} \}}_{est} = \sqrt{\frac{π}{2}} L {σ}_{est} \qquad ( 22 )$$

### Detection Threshold

Once an interference level estimate is available, a detection threshold can be set to satisfy a given design criteria such as the probability of false alarm in detecting a finger. Alternatively, as it is reported in Fukumoto, the finger detection threshold can be chosen as the interference level estimate multiplied by a scalar. The present inventors have also found that such an approach suffices for conformance with accepted network base station conformance testing requirements.

### Experimental Results

Experiments are conducted to validate the estimator in (22), where various PM search window sizes, W, and non-coherent combinings L are used. Results obtained in Monte Carlo Simulations are averaged over 10000 trials. The interference level to be estimated is set to 100. Table 3 shows the mean value of the interference level estimate averaged over the Monte Carlo trials. Table 4 gives the standard deviation of the estimates corresponding to Table 3. It is interesting that the standard deviation of the estimates seems to be independent of the PM search window size, W. Also the standard deviation reduces with increasing L. The mean value of the estimator in all cases is sufficiently accurate.

TABLE 2
Various numerically computed values of ξp, L, W = E{Z p, L, W}, σ = 1.

| | | | | |
|---|---|---|---|---|
| L | p = W | p = W − 1 | p = W − 2 | p = W − 3 |

ξp, L, W = 32

| | | | | |
|---|---|---|---|---|
| 1 | 0.23 | 0.34 | 0.42 | 0.49 |
| 2 | 0.89 | 1.13 | 1.29 | 1.42 |
| 4 | 2.58 | 3.00 | 3.26 | 3.46 |
| 8 | 6.47 | 7.18 | 7.51 | 7.81 |

ξp, L, W = 64

| | | | | |
|---|---|---|---|---|
| 1 | 0.16 | 0.24 | 0.30 | 0.34 |
| 2 | 0.74 | 0.93 | 1.06 | 1.16 |
| 4 | 2.32 | 2.67 | 2.89 | 3.05 |
| 8 | 6.05 | 6.61 | 6.94 | 7.19 |

ξp, L, W = 96

| | | | | |
|---|---|---|---|---|
| 1 | 0.13 | 0.20 | 0.24 | 0.28 |
| 2 | 0.66 | 0.83 | 0.95 | 1.03 |
| 4 | 2.18 | 2.50 | 2.70 | 2.84 |
| 8 | 5.82 | 6.35 | 6.66 | 6.88 |

ξp, L, W = 128

| | | | | |
|---|---|---|---|---|
| 1 | 0.12 | 0.17 | 0.21 | 0.24 |
| 2 | 0.62 | 0.77 | 0.87 | 0.95 |
| 4 | 2.09 | 2.40 | 2.58 | 2.71 |
| 8 | 5.69 | 6.18 | 6.47 | 6.68 |

TABLE 3
Mean of Estimate E{ZL}est.
Mean of the Estimator

| L | W = 32 | W = 64 | W = 96 | W = 128 |
|---|---|---|---|---|
| 2 | 100.13 | 99.34 | 100.57 | 100.12 |
| 3 | 100.09 | 100.41 | 100.91 | 100.03 |
| 4 | 99.48 | 100.45 | 100.02 | 99.14 |
| 5 | 99.93 | 100.28 | 100.53 | 99.92 |
| 6 | 99.91 | 100.03 | 100.25 | 99.89 |
| 7 | 100.15 | 100.00 | 99.78 | 100.27 |
| 8 | 99.80 | 100.06 | 99.58 | 100.08 |

TABLE 4
Standard Deviation of Estimate E{ZL}est.
Standard Deviation of the Estimator

| L | W = 32 | W = 64 | W = 96 | W = 128 |
|---|---|---|---|---|
| 2 | 17.74 | 17.10 | 17.28 | 16.99 |
| 3 | 13.30 | 12.63 | 12.57 | 12.30 |
| 4 | 10.63 | 10.40 | 10.09 | 9.82 |
| 5 | 9.39 | 8.87 | 8.67 | 8.35 |
| 6 | 8.35 | 7.88 | 7.63 | 7.37 |
| 7 | 7.62 | 7.06 | 6.95 | 6.72 |
| 8 | 7.02 | 6.54 | 6.21 | 6.14 |

As described above, a new interference estimation technique is disclosed for WCDMA where the order statistics of the PM search profile is used to determine the interference level and finger detection threshold. The noise floor is statistically distributed according to Beaulieu Series for which new analytical results are also presented. The proposed technique is computationally very efficient and accurate.

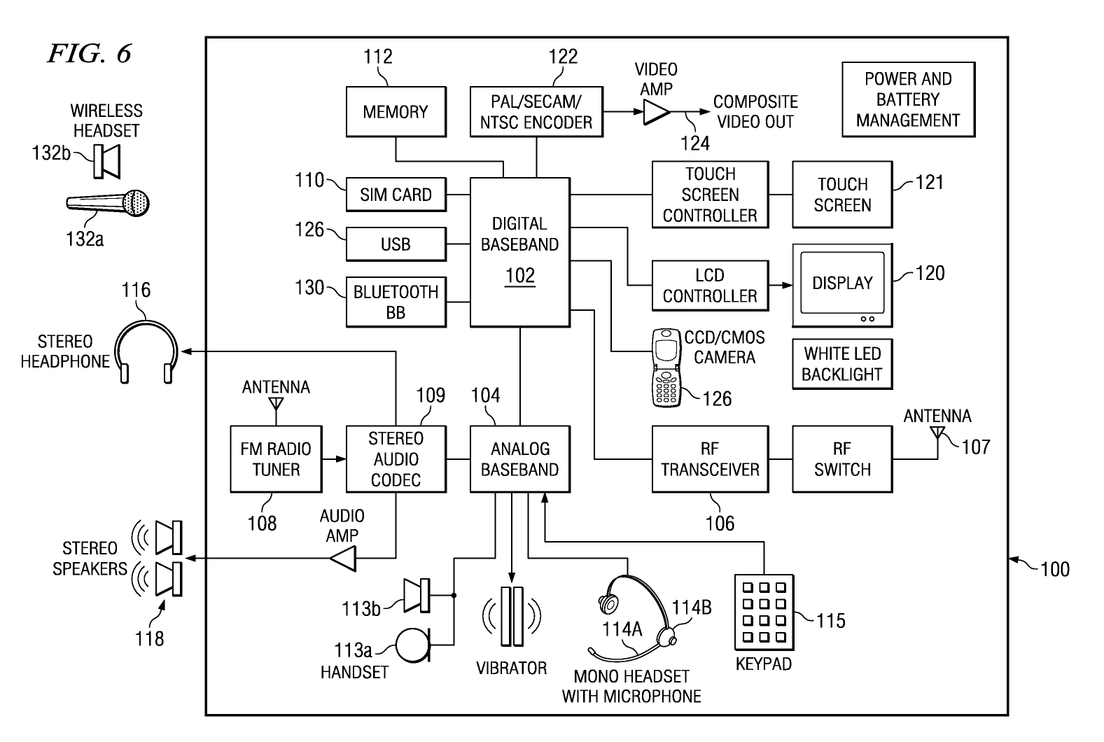

FIG. 6 is a block diagram of a representative cell phone 100 that includes an embodiment of the present invention for interference level estimation and finger detection threshold for path monitoring. Digital baseband (DBB) unit 102 is a digital processing processor system that includes embedded memory and security features. In this embodiment, DBB 102 is an open media access platform (OMAP™) available from Texas Instruments designed for multimedia applications. Some of the processors in the OMAP family contain a dual-core architecture consisting of both a general-purpose host ARM™ (advanced RISC (reduced instruction set processor) machine) processor and one or more DSP (digital signal processor). The digital signal processor featured is commonly one or another variant of the Texas Instruments TMS320 series of DSPs. The ARM architecture is a 32-bit RISC processor architecture that is widely used in a number of embedded designs.

Although the invention finds particular application to Digital Signal Processors (DSPs), implemented, for example, in an Application Specific Integrated Circuit (ASIC), it also finds application to other forms of processors. An ASIC may contain one or more megacells which each include custom designed functional circuits combined with pre-designed functional circuits provided by a design library.

Analog baseband (ABB) unit 104 performs processing on audio data received from stereo audio codec (coder/decoder) 109. Audio codec 109 receives an audio stream from FM Radio tuner 108 and sends an audio stream to stereo headset 116 and/or stereo speakers 118. In other embodiments, there may be other sources of an audio stream, such a compact disc (CD) player, a solid state memory module, etc. ABB 104 receives a voice data stream from handset microphone 113a and sends a voice data stream to handset mono speaker 113b. ABB 104 also receives a voice data stream from microphone 114a and sends a voice data stream to mono headset 114b. Usually, ABB and DBB are separate ICs. In most embodiments, ABB does not embed a programmable processor core, but performs processing based on configuration of audio paths, filters, gains, etc being setup by software running on the DBB. In an alternate embodiment, ABB processing is performed on the same OMAP processor that performs DBB processing. In another embodiment, a separate DSP or other type of processor performs ABB processing.

RF transceiver 106 includes a receiver for receiving a stream of coded data frames from a cellular base station via antenna 107 and a transmitter for transmitting a stream of coded data frames to the cellular base station via antenna 107. In this embodiment, multiple transceivers are provided in order to support both GSM and WCDMA operation. Other embodiments may have only one type or the other, or may have transceivers for a later developed transmission standard. In other embodiments, a single transceiver may be configured to support multiple Radio Access Technologies. RF transceiver 106 is connected to DBB 102 which provides processing of the frames of encoded data being received and transmitted by cell phone 100.

The basic WCDMA DSP radio consists of control and data channels, rake energy correlations, path selection, rake decoding, and radio feedback. Interference estimation and path selection as described above is performed by instructions stored in memory 112 and executed by DBB 102 in response to signals received by transceiver 106.

DBB unit 102 may send or receive data to various devices connected to USB (universal serial bus) port 126. DBB 102 is connected to SIM (subscriber identity module) card 110 and stores and retrieves information used for making calls via the cellular system. DBB 102 is also connected to memory 112 that augments the onboard memory and is used for various processing needs. DBB 102 is connected to Bluetooth baseband unit 130 for wireless connection to a microphone 132a and headset 132b for sending and receiving voice data.

DBB 102 is also connected to display 120 and sends information to it for interaction with a user of cell phone 100 during a call process. Display 120 may also display pictures received from the cellular network, from a local camera 126, or from other sources such as USB 126.

DBB 102 may also send a video stream to display 120 that is received from various sources such as the cellular network via RF transceiver 106 or camera 126. DBB 102 may also send a video stream to an external video display unit via encoder 122 over composite output terminal 124. Encoder 122 provides encoding according to PAL/SECAM/NTSC video standards.

As used herein, the terms “applied,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

While the invention has been described with reference to illustrative embodiments, this description is not intended to be construed in a limiting sense. Various other embodiments of the invention will be apparent to persons skilled in the art upon reference to this description. Other embodiments may comprise a portable computer with a wireless modem or a wireless modem card for a computer, various personal assistant devices with wireless communication capabilities, etc.

It is therefore contemplated that the appended claims will cover any such modifications of the embodiments as fall within the true scope and spirit of the invention.

What is claimed is:

1. A method for operating a WCDMA radio receiver, comprising:
receiving in-phase and quadrature input samples of a WCDMA radio frequency message; and
correlating a locally generated copy of a dedicated physical control channel (DPCCH) with the input samples of the radio frequency message using low order statistics of a Beaulieu Series to estimate an interference level and thereby implicitly separate a set of multipath components from a noise floor.

2. The method of claim 1, wherein the estimate of the interference level is given using M lowest observations of the Beaulieu Series for W independent observations of a Beaulieu Series of sum of L independent identically distributed (i.i.d) Rayleigh random variables by
$$\begin{matrix}E {\{ {Z}_{L} \}}_{est} = \sqrt{\frac{π}{2}} L {σ}_{est} \\ where & ( 22 ) \\ {σ}_{est} = \frac{1}{M} {\sum }_{i = W - M + 1}^{W} \frac{{Z}_{i , L , W}}{{ξ}_{i , L , W}} & ( 21 )\end{matrix}$$

3. The method of claim 2, wherein the correlation between the incoming WCDMA signal and a locally generated reference are computed over a search window for a number of coherent accumulations which are Rayleigh distributed.

4. The method of claim 1, further comprising indentifying a set of multipath signals that exceed the interference level estimate.

5. The method of claim 4, further comprising:
de-spreading the set of multipath signals;
combining the set of multipath signals; and
symbol rate decoding the combined multipath signals to retrieve data encoded in the WCDMA radio frequency message.

6. A WCDMA radio receiver, comprising:
circuitry for receiving in-phase and quadrature input samples of a WCDMA radio frequency message; and
circuitry operable to correlate a locally generated copy of a dedicated physical control channel (DPCCH) with the input samples of the radio frequency message using low order statistics of a Beaulieu Series to estimate an interference level and thereby implicitly separate a set of multipath components from a noise floor.

7. The radio receiver of claim 6, wherein the estimate of the interference level is given using M lowest observations of the Beaulieu Series for W independent observations of a Beaulieu Series of sum of L independent identically distributed (i.i.d) Rayleigh random variables by an equation
$$\begin{matrix}E {\{ {Z}_{L} \}}_{est} = \sqrt{\frac{π}{2}} L {σ}_{est} \\ where & ( 22 ) \\ {σ}_{est} = \frac{1}{M} {\sum }_{i = W - M + 1}^{W} \frac{{Z}_{i , L , W}}{{ξ}_{i , L , W}} & ( 21 )\end{matrix}$$

8. The radio receiver of claim 7, wherein the correlation between the incoming WCDMA signal and a locally generated reference are computed over a search window for a number of coherent accumulations which are Rayleigh distributed.

9. The radio receiver of claim 6, further comprising circuitry operable to indentify a set of multipath signals that exceed the interference level estimate.

10. The radio receiver of claim 9, further comprising:
circuitry operable to de-spread the set of multipath signals;
circuitry operable to combine the set of multipath signals; and
circuitry operable to symbol rate decode the combined multipath signals to retrieve data encoded in the WCDMA radio frequency message.

11. The radio receiver of claim 7 being included in a mobile device, further comprising a digital signal processor (DSP) connected to memory for holding instructions for execution by the DSP and for holding data for use by the DSP, the DSP being connected to receive digitized representations of the in-phase and quadrature input samples from the radio receiver, wherein the DSP is operable to execute a portion of the instructions to estimate the interference level according to the equation.

12. A digital system, comprising:
circuitry for receiving in-phase and quadrature input samples of a WCDMA radio frequency message;
circuitry connected to the receiving circuitry operable to convert the in-phase and quadrature input samples to digital representations; and
a digital signal processor (DSP) connected to memory for holding instructions for execution by the DSP and for holding data for use by the DSP, the DSP being connected to receive the digital representations of the in-phase and quadrature input samples from the radio receiver, wherein the DSP is operable to execute a portion of the instructions to correlate a locally generated copy of a dedicated physical control channel (DPCCH) with the input samples of the radio frequency message using low order statistics of a Beaulieu Series to estimate an interference level and thereby implicitly separate a set of multipath components from a noise floor.

13. The digital system of claim 12, wherein the estimate of the interference level is given using M lowest observations of the Beaulieu Series for W independent observations of a Beaulieu Series of sum of L independent identically distributed (i.i.d) Rayleigh random variables by an equation
$$\begin{matrix}E {\{ {Z}_{L} \}}_{est} = \sqrt{\frac{π}{2}} L {σ}_{est} \\ where & ( 22 ) \\ {σ}_{est} = \frac{1}{M} {\sum }_{i = W - M + 1}^{W} \frac{{Z}_{i , L , W}}{{ξ}_{i , L , W}} & ( 21 )\end{matrix}$$

14. The digital system of claim 13, wherein the correlation between the incoming WCDMA signal and a locally generated reference are computed by the DSP over a search window for a number of coherent accumulations which are Rayleigh distributed.

15. The digital system of claim 13, further comprising instructions stored in the memory executable by the DSP to indentify a set of multipath signals that exceed the interference level estimate.

16. The digital system of claim 15, further comprising:
instructions stored in the memory executable by the DSP to de-spread the set of multipath signals;
instructions stored in the memory executable by the DSP to combine the set of multipath signals; and
instructions stored in the memory executable by the DSP to symbol rate decode the combined multipath signals to retrieve data encoded in the WCDMA radio frequency message.

17. The digital system of claim 15 being a cellular telephone.
